(19) United States
(12) Patent Application Publication
(10) Pub. No.: US 2026/0268818 A1
(43) Pub. Date: Sep. 10, 2026

(54) METHOD AND APPARATUS FOR DEBUGGING DRIVING WAVEFORMS OF E-PAPER DISPLAY DEVICE, DEVICE AND MEDIUM

(71) Applicant: BOE Technology Group Co., Ltd., Beijing (CN)

(72) Inventors: Xibo Zhou, Beijing (CN); Jinxiao Wen, Beijing (CN)

(73) Assignee: BOE Technology Group Co., Ltd., Beijing (CN)

(21) Appl. No.: 18/993,677

(22) PCT Filed: Apr. 18, 2024
(86) PCT No.: PCT/CN2024/088669

§ 371 Date: Jan. 13, 2025

(30) Foreign Application Priority Data
May 24, 2023 (CN) 202310596669.0

(51) Int. Cl. G09G 3/00; G09G 3/34

(52) U.S. Cl. CPC G09G 3/006; G09G 3/344; G09G 2310/06; G09G 2320/08; G09G 2330/12; G09G 2354/00; G09G 2360/145

(57) ABSTRACT

A method for debugging driving waveforms of an e-paper display device comprises: for an e-paper display device to be debugged, carrying out multiple times of iterative debugging process on driving waveforms of the e-paper display device; when the multiple times of iterative debugging process meet a target condition, acquiring a target driving waveform corresponding to the final iterative debugging process; and taking the target driving waveform as the driving waveform of the e-paper display device in actual driving, wherein during each time of iterative debugging process, second driving waveform information corresponding to the iterative debugging process is acquired on the basis of first driving waveform information corresponding to the previous iterative debugging process and a debugging network, the e-paper display device is debugged on the basis of the second driving waveform information, and the debugging network is updated on the basis of a debugging result.

### CROSS-REFERENCE TO RELATED APPLICATION

This application claims priority to Chinese Patent Application No. 202310596669.0, entitled “Method and apparatus for debugging driving waveforms of an e-paper display device, a device and a medium”, filed on May 24, 2023, by China Patent Office, the entire contents of which are incorporated herein by reference.

### TECHNICAL FIELD

Embodiments of the present disclosure relate to the field of display technology, and more particularly, to a debugging method and apparatus for a driving waveform of an electronic paper device, a device and a medium.

### BACKGROUND

Electro-Phoretic Display is a paper-like display technology with low energy consumption. By continuously applying drive voltage to the display area, the colored particles in the electronic paper device undergo electrophoresis phenomenon, thereby displaying a designated image. Such a continuously applied drive voltage is referred to as a driving waveform (WF) of the electronic paper device, and the quality thereof directly determines the display effect of the electro-phoretic display.

Nowadays, in order to save manpower cost, the automatic debugging method of a driving waveform of an electronic paper device has become the research direction in the current field. However, a complete driving waveform has hundreds of adjustable parameters, the trial and error cost by a violent and exhaustive manner is too high, and the debugging experience varies from person to person. Thus, it is difficult to summarize and sort the same into flow debugging logic, which makes the automatic debugging of the driving waveform of the electronic paper device a difficult problem.

### SUMMARY

Embodiments of the present disclosure are directed to a debugging method and apparatus for a driving waveform of an electronic paper device, a device and a medium to solve the problem of how to streamline the debugging of the driving waveform of the electronic paper device.

A first aspect of an embodiment of the present disclosure provides a debugging method for a driving waveform of an electronic paper device, including:
performing a plurality of iterative debugging processes on a driving waveform of the electronic paper device for an electronic paper device to be debugged;
acquiring a target driving waveform corresponding to a latest iterative debugging process when the a plurality of iterative debugging processes satisfies a target condition; and
taking the target driving waveform as a driving waveform of the electronic paper device in an actual drive;
wherein, during each iterative debugging process, acquiring second driving waveform information corresponding to the iterative debugging process based on first driving waveform information and a debugging network corresponding to the last-time iterative debugging process, debugging the electronic paper device based on the second driving waveform information, and updating the debugging network based on a debugging result;
wherein the debugging network is at least used for acquiring adjustment information for adjusting the first driving waveform information based on the input first driving waveform information, and the second driving waveform information is obtained based on the adjustment information and the first driving waveform information.

In an alternative embodiment, the debugging the electronic paper device based on the second driving waveform information comprises:
performing image refreshing on the electronic paper device based on the second driving waveform information to obtain a first display image;
performing optical detection on the first display image to acquire an optical measurement value corresponding to the first display image; and
acquiring the debugging result based on the optical measurement value and a reference optical value of the electronic paper device.

In an alternative embodiment, the acquiring the debugging result based on the optical measurement value and the reference optical value comprises:
acquiring a first reward parameter value based on the optical measurement value and the reference optical value, wherein the first reward parameter value is used for characterizing environmental feedback when the first driving waveform information is adjusted according to the adjustment information; and
determining the debugging result based on the first reward parameter value.

In an alternative embodiment, the reference optical value comprises a maximum reference optical value and a minimum reference optical value; and the acquiring a first reward parameter value based on the optical measurement value and the reference optical value comprises:
if the optical measurement value is less than or equal to the maximum reference optical value and is larger than or equal to the minimum reference optical value, taking 0 as the first reward parameter value;
if the optical measurement value is larger than the maximum reference optical value, taking a difference between the optical measurement value and the maximum reference optical value as the first reward parameter value; and
if the optical measurement value is less than the minimum reference optical value, taking the difference between the optical measurement value and the minimum reference optical value as the first reward parameter value.

In an alternative embodiment, the electronic paper device comprises a plurality of colors, and the debugging the electronic paper device based on the second driving waveform information comprises:
performing image refreshing on the electronic paper device based on the second driving waveform information to obtain a second display image, wherein the second display image comprises a plurality of color zones;
performing optical detection on each color zone to acquire an optical measurement value corresponding to the each color zone;
acquiring an optical difference value corresponding to each color zone based on an optical measurement value corresponding to each color zone and a reference optical value of each color zone; and
determining the debugging result based on the corresponding optical difference values for all the color zones.

In an alternative embodiment, the determining the debugging result based on the corresponding optical difference values for all the color zones comprises:
taking the sum of the optical difference values corresponding to all the color zones as the second reward parameter value; and
determining the debugging result based on the second reward parameter value.

In an alternative embodiment, the debugging network comprises a first sub-network and a second sub-network, the first sub-network is configured for outputting adjustment information for adjusting the first driving waveform information, and the updating the debugging network based on the debugging result comprises:
inputting the second driving waveform information into the second sub-network to obtain a first expected revenue when the debugging result indicates that the debugging process does not pass, wherein the first expected revenue is used for indicating the revenue of the debugging network for adjusting the first driving waveform information based on the adjustment information; and
updating a parameter of the first sub-network based on the first expected revenue.

In an alternative embodiment, the debugging network further comprises a third sub-network and a fourth sub-network, and the updating the debugging network based on the debugging result comprises:
inputting the second driving waveform information into the third sub-network to acquire adjustment information for adjusting the second driving waveform information in the case where the debugging result indicates that the debugging process does not pass;
inputting the second driving waveform information and the adjustment information for adjusting the second driving waveform information into the fourth sub-network to obtain a second expected revenue, wherein the second expected revenue is used for characterizing the revenue of the debugging network for adjusting the second driving waveform information based on the adjustment information; and
updating a parameter of the second sub-network based on the second expected revenue and the first reward parameter value.

In an alternative embodiment, the updating the debugging network based on the debugging result comprises:
updating a parameter of the third sub-network based on the updated parameter of the first sub-network; and
updating a parameter of the fourth sub-network based on the updated parameter of the second sub-network.

In an alternative embodiment, before acquiring first driving waveform information, the method further comprises:
displaying a parameter setting interface of the debugging network;
performing an update coefficient setting on the debugging network in response to an update coefficient input by a user via the parameter setting interface, wherein the update coefficient is used for adjusting a parameter update process of the debugging network.

In an alternative embodiment, after the taking the target driving waveform as a driving waveform of the electronic paper device in an actual drive, the method further comprises:
acquiring a driving waveform frame and driving waveform pulse information based on the target driving waveform, wherein the driving waveform frame is used for characterizing a voltage sequence of the target driving waveform, and the driving waveform pulse information is used for characterizing the number of pulses and the number of cycles under the driving waveform frame;
performing program compilation on the driving waveform frame and the driving waveform pulse information to obtain an electronic paper device drive program; and
executing the electronic paper device drive program to refresh the electronic paper device according to the target driving waveform to form a first target display image.

In an alternative embodiment, the electronic paper device is a first type of electronic paper device, and after the taking the target driving waveform as a driving waveform of the electronic paper device in an actual drive, the method further comprises:

driving a second type of an electronic paper device based on the target driving waveform, wherein the second type of the electronic paper device comprises the same type of color as the first type of electronic paper device.

The second aspect of the present disclosure discloses debugging apparatus for a driving waveform of an electronic paper device, comprising:
an iterative debugging process module configured for performing a plurality of iterative debugging processes on a driving waveform of the electronic paper device for an electronic paper device to be debugged;
a determining module configured for acquiring a target driving waveform corresponding to a latest iterative debugging process when the a plurality of iterative debugging processes satisfies a target condition;
a driving waveform acquisition module configured for taking the target driving waveform as a driving waveform of the electronic paper device in an actual drive; and
a single iteration module configured for, during each iterative debugging process, acquiring second driving waveform information corresponding to the iterative debugging process based on first driving waveform information and a debugging network corresponding to the last-time iterative debugging process, debugging the electronic paper device based on the second driving waveform information, and updating the debugging network based on a debugging result; wherein the debugging network is at least used for acquiring adjustment information for adjusting the first driving waveform information based on the input first driving waveform information, and the second driving waveform information is obtained based on the adjustment information and the first driving waveform information.

In an alternative embodiment, the single iteration module includes:
a first display sub-module configured for performing image refreshing on the electronic paper device based on the second driving waveform information to obtain a first display image;
a first detection sub-module configured for performing optical detection on the first display image to acquire an optical measurement value corresponding to the first display image; and
a first result acquisition sub-module configured for acquiring the debugging result based on the optical measurement value and a reference optical value of the electronic paper device.

In an alternative embodiment, the single iteration module includes:
a first reward sub-module configured for acquiring a first reward parameter value based on the optical measurement value and the reference optical value, wherein the first reward parameter value is used for characterizing environmental feedback when the first driving waveform information is adjusted according to the adjustment information; and
a second result acquisition sub-module configured for determining the debugging result based on the first reward parameter value.

In an alternative embodiment, the first reward sub-module includes:
a first reward acquisition unit configured for, if the optical measurement value is less than or equal to the maximum reference optical value and is larger than or equal to the minimum reference optical value, taking 0 as the first reward parameter value;
a second reward acquisition unit configured for, if the optical measurement value is larger than the maximum reference optical value, taking a difference between the optical measurement value and the maximum reference optical value as the first reward parameter value; and
a third reward acquisition unit configured for, if the optical measurement value is less than the minimum reference optical value, taking the difference between the optical measurement value and the minimum reference optical value as the first reward parameter value.

In an alternative embodiment, the single iteration module includes:
a second display sub-module configured for performing image refreshing on the electronic paper device based on the second driving waveform information to obtain a second display image, wherein the second display image includes a plurality of color zones;
a second detection sub-module configured for performing optical detection on each color zone to acquire an optical measurement value corresponding to the each color zone;
a difference acquisition sub-module configured for acquiring an optical difference value corresponding to each color zone based on an optical measurement value corresponding to each color zone and a reference optical value of each color zone; and
a third result acquisition sub-module configured for determining the debugging result based on the corresponding optical difference values for all the color zones.

In an alternative embodiment, the third result acquisition sub-module includes:
a second reward unit configured for taking the sum of the optical difference values corresponding to all the color zones as the second reward parameter value; and
a third result acquisition unit configured for determining the debugging result based on the second reward parameter value.

In an alternative embodiment, the single iteration module includes:
a first revenue sub-module configured for inputting the second driving waveform information into the second sub-network to obtain a first expected revenue when the debugging result indicates that the debugging process does not pass, wherein the first expected revenue is used for indicating the revenue of the debugging network for adjusting the first driving waveform information based on the adjustment information; and
a first updating sub-module configured for updating a parameter of the first sub-network based on the first expected revenue.

In an alternative embodiment, the single iteration module includes:
an adjustment sub-module configured for inputting the second driving waveform information into the third sub-network to acquire adjustment information for adjusting the second driving waveform information in the case where the debugging result indicates that the debugging process does not pass;
a second revenue sub-module configured for inputting the second driving waveform information and the adjustment information for adjusting the second driving waveform information into the fourth sub-network to obtain a second expected revenue, wherein the second expected revenue is used for characterizing the revenue of the debugging network for adjusting the second driving waveform information based on the adjustment information; and
a second update sub-module configured for updating a parameter of the second sub-network based on the second expected revenue and the first reward parameter value.

In an alternative embodiment, the single iteration module includes:
a third updating sub-module configured for updating a parameter of the third sub-network based on the updated parameter of the first sub-network; and
a fourth updating sub-module configured for updating a parameter of the fourth sub-network based on the updated parameter of the second sub-network.

In an alternative embodiment, the single iteration module includes:
an interface display sub-module configured for displaying a parameter setting interface of the debugging network; and
a coefficient setting sub-module configured for performing an update coefficient setting on the debugging network in response to an update coefficient input by a user via the parameter setting interface, wherein the update coefficient is used for adjusting a parameter update process of the debugging network.

In an alternative embodiment, the apparatus further includes:
a parsing module configured for acquiring a driving waveform frame and driving waveform pulse information based on the target driving waveform, wherein the driving waveform frame is used for characterizing a voltage sequence of the target driving waveform, and the driving waveform pulse information is used for characterizing the number of pulses and the number of cycles under the driving waveform frame;
a compilation module configured for performing program compilation on the driving waveform frame and the driving waveform pulse information to obtain an electronic paper device drive program; and a second target display module configured for executing the electronic paper device drive program to refresh the electronic paper device according to the target driving waveform to form a first target display image.

In an alternative embodiment, the apparatus further includes:
a drive module configured for driving a second type of an electronic paper device based on the target driving waveform, wherein the second type of the electronic paper device includes the same type of color as the first type of electronic paper device.

The third aspect of the present disclosure discloses a computing processing device, comprising:
a memory in which a computer readable code is stored; and
one or more processors, wherein when the computer readable code is executed by the one or more processors, the computing processing device perform the debugging method for the driving waveform of the electronic paper device according to one of the aspects above.

The fourth aspect of the present disclosure discloses a computer-readable medium having stored thereon computer programs/instructions, wherein the computer programs/instructions when executed by a processor implement the debugging method for the driving waveform of the electronic paper device according to one of the aspects above.

### Beneficial Effects

The present disclosure provides a debugging method and apparatus for a driving waveform of an electronic paper device, a device and a medium, the method including: performing a plurality of iterative debugging processes on a driving waveform of the electronic paper device for an electronic paper device to be debugged; acquiring a target driving waveform corresponding to a latest iterative debugging process when the a plurality of iterative debugging processes satisfies a target condition; and taking the target driving waveform as a driving waveform of the electronic paper device in an actual drive; wherein, during each iterative debugging process, acquiring second driving waveform information corresponding to the iterative debugging process based on first driving waveform information and a debugging network corresponding to the last-time iterative debugging process, debugging the electronic paper device based on the second driving waveform information, and updating the debugging network based on a debugging result; wherein the debugging network is at least used for acquiring adjustment information for adjusting the first driving waveform information based on the input first driving waveform information, and the second driving waveform information is obtained based on the adjustment information and the first driving waveform information.

The present disclosure performs automatic adjustment on a driving waveform based on a debug network architecture of reinforcement learning, and at the same time obtains feedback of the adjusted driving waveform to the debugging of driving waveform of the electronic paper device, so as to perform iterative update on the debugging network, avoiding the problem of high trial and error cost caused by debugging in a violent and exhaustive manner, and enabling the debugging of the driving waveform of the electronic paper device to be performed in a flow chart manner.

The above description is merely an overview of the technical solution of this disclosure. In order to better understand the technical means of this disclosure, one may implement it according to the content of the specification. Moreover, in order to make the aforementioned and other objectives, features, and advantages of this disclosure more apparent and understandable, the following specific embodiments of this disclosure are provided.

### BRIEF DESCRIPTION OF THE DRAWINGS

In order to more clearly illustrate the technical solutions in the embodiments of this disclosure or in the related art, a brief introduction to the figures that will be used in the description of the embodiments or related art is provided below. It is evident that the figures described below are some embodiments of this disclosure. For a skilled person in the art, without exerting any creative labor, they can also obtain other figures based on these figures.

FIG. 1 schematically shows a debugging method flowchart of driving waveform of an electronic paper device for performing a method according to the present disclosure;

FIG. 2 schematically shows a flowchart for each iteration of a debugging of driving waveform of an electronic paper device for performing the method according to the present disclosure;

FIG. 3 schematically shows a debugging flow diagram of driving waveform of an electronic paper device for performing the method according to the present disclosure;

FIG. 4 schematically shows a debugging diagram of multiple temperature sections of driving waveform of an electronic paper device for performing the method according to the present disclosure;

FIG. 5 schematically shows a debugging apparatus for driving waveform of an electronic paper device for performing the method according to the present disclosure; and

FIG. 6 schematically shows a computing processing device for performing the method according to the present disclosure.

### DETAILED DESCRIPTION OF THE EMBODIMENTS

To make the objectives, technical solutions, and advantages of the embodiments of this disclosure clearer, the technical solutions of the embodiments of this disclosure will be described clearly and completely below in conjunction with the figures of the embodiments. Obviously, the described embodiments are only part of the embodiments of this disclosure, not all of them. All other embodiments obtained by ordinary persons in the art without making any creative labor based on the embodiments of this disclosure are within the scope of protection of this disclosure.

Electro-Phoretic Display (EPD) is a paper-like display technology with low energy consumption. By continuously applying drive voltage to the display area, the colored particles in the electronic paper device undergo electrophoresis phenomenon, thereby displaying a designated image. This continuously applied drive voltage is the driving waveform (WF) of the electronic paper device, the quality of which directly determines the display effect of the electro-phoretic display (EPD). Due to the influence of environmental temperature, moisture, substrate electrical characteristics, capacitive reactance, impedance and other factors, it is difficult for the electronic paper device module to develop the driving waveform which meets the quality inspection standards.

In the conventional technology, the driving waveform of the electronic paper device is manually debugged, and the debugging efficiency and stability of acquiring driving waveform of an electronic paper device are poor due to the uneven level of a debugger. In recent years, some manufacturers have tried to build automatic debugging devices of the driving waveform to save manpower cost. However, a complete driving waveform has hundreds of adjustable parameters, the trial and error cost by a violent and exhaustive manner is too high, and the debugging experience varies from person to person. Thus, it is difficult to summarize and sort the same into flow debugging logic, which makes the automatic debugging of the driving waveform a difficult problem.

In view of this, embodiments of the present disclosure propose a debugging method for a driving waveform of an electronic paper device. FIG. 1 schematically shows a debugging method flowchart of driving waveform of an electronic paper device for performing a method according to the present disclosure. As shown in FIG. 1, the method includes the steps below.

S101, performing a plurality of iterative debugging processes on a driving waveform of the electronic paper device for an electronic paper device to be debugged;

wherein, during each iterative debugging process, acquiring second driving waveform information corresponding to the iterative debugging process based on first driving waveform information and a debugging network corresponding to the last-time iterative debugging process, debugging the electronic paper device based on the second driving waveform information, and updating the debugging network based on a debugging result;

wherein the debugging network is at least used for acquiring adjustment information for adjusting the first driving waveform information based on the input first driving waveform information, and the second driving waveform information is obtained based on the adjustment information and the first driving waveform information;

S102, acquiring a target driving waveform corresponding to a latest iterative debugging process when the a plurality of iterative debugging processes satisfies a target condition; and

S103, taking the target driving waveform as a driving waveform of the electronic paper device in an actual drive.

In the embodiments of the present disclosure, the electronic paper device to be debugged may be a common electronic paper device, including but not limited to a two-color electronic paper device (a two-color electronic paper device includes not only a black and white electronic paper device, but also a white and red electronic paper device, a black and red electronic paper device, etc.), a three-color electronic paper device (such as a three-color electronic paper device including black, white and red, etc.), a four-color electronic paper device (such as a four-color electronic paper device including black, white, red, yellow, etc.) and the like.

In the embodiments of the present disclosure, the driving waveform information in the first driving waveform information and the second driving waveform information is a waveform of a source signal and a common electrode signal which are sequentially applied during a refresh process by the electronic paper device. The driving waveform information includes at least one of the following: a drive voltage and a reference voltage, a drive frequency, a driving waveform frame and driving waveform pulse information of various colored particles.

Herein, with regard to the drive voltage and the reference voltage of the colored particles, these parameters are only affected by the material of the electronic paper device. Therefore, the drive voltage and the reference voltage of the colored particles in the driving waveform information can be measured before debugging the driving waveform of the electronic paper device. The drive frequency affects the refreshing time of the electronic paper device. Since the refreshing time is often limited by the upper limit in the quality inspection specification, the drive frequency in the driving waveform information needs to be set in a reasonable range, and is rarely adjusted in the debugging process. The driving waveform frame refers to a voltage sequence adopted by a driving waveform, and generally includes a balance phase, a shaking phase and an image phase. Here, each phase is composed of at least one stage (the balance, the balance phase and the shaking phase generally being composed of 1-3 stages, and the image phase generally being composed of 2-4 stages). Each stage includes a plurality of time-sequential voltage segments, and each segment can select one of a drive voltage and a reference voltage of a colored particle. The driving waveform frame can be adjusted in the debugging process of the driving waveform. When the driving waveform frame needs to be adjusted, the input driving waveform information contains relevant information about the driving waveform frame. The driving waveform pulse information refers to a plurality of sequential pulses and the number of cycles of each stage of the driving waveform under a selected driving waveform frame and drive frequency. The driving waveform pulse information can be represented in the form of a matrix (namely, a driving waveform pulse matrix), and can also be represented in other forms. Corresponding to the driving waveform frame, the driving waveform pulse information includes a plurality of sequential pulse numbers and the number of cycles, and the value range of each value is [0x00, 0xff] (hexadecimal). The driving waveform pulse information is a main debugging object in the debugging process of the driving waveform.

For example, with regard to a three-color electronic paper device of black, white and red, the device includes a drive voltage for pushing black particles (referred to as a black voltage), a drive voltage for pushing white particles (referred to as a white voltage), a drive voltage for pushing red particles (referred to as a red voltage) and a reference voltage. The black voltage and the white voltage are generally about +15 V or −15 V, the red voltage is generally between 0 V and the black voltage, and the reference voltage is generally about OV. The drive voltage and the reference voltage of the colored particles are determined in advance before debugging the driving waveform of the three-color electronic paper device, and no adjustment is made in the iterative debugging process of the driving waveform. The drive frequency is set before the iterative debugging process of the driving waveform, and no adjustment is made in the iterative debugging process of the driving waveform; wherein a red zone and a black/white zone in a driving waveform frame are usually performed at different stage, each stage includes four time-sequential voltage segments, and one of black/white/red/reference voltages can be selected for each segment. When it is required to perform debugging on the driving waveform frame, the driving waveform frame and driving waveform pulse information about an electronic paper device currently to be debugged are input as driving waveform information to a debugging network for debugging.

The debugging network is at least used for generating adjustment information corresponding to the driving waveform information based on the input driving waveform information. The adjustment information is adjustment information regarding the driving waveform pulse information, and the structure of the adjustment information is the same as that of the driving waveform pulse information. For example, when the driving waveform pulse information is a driving waveform pulse matrix, the adjustment information is a driving waveform pulse adjustment matrix, and each value in the driving waveform pulse adjustment matrix characterizes an adjustment amplitude of a corresponding position in the driving waveform pulse matrix, and characterizes an adjustment direction by positive and negative (a positive value indicate an upward adjustment, and a negative value indicates a downward adjustment).

The debugging network debugs the driving waveform information based on the reinforcement learning algorithm. In the embodiments of the present disclosure, in the debugging process of the driving waveform of the electronic paper device, the environment is a debugging device for debugging the driving waveform. The intelligent agent is an electronic paper device drive program. The first driving waveform information is state information about the current state. The debugging network generates adjustment information regarding the first driving waveform information as an action executed regarding the current state, and executes corresponding adjustment information regarding the first driving waveform information to obtain second driving waveform information which is used as state information about the next state. During each iterative debugging process, the debugging network is updated based on the feedback from interacting with the environment and acquisition of the state information of the next state, so that the debugging network is continuously optimized during the iteration until the target condition can be met.

In order for those skilled in the art to better understand the aspects of the present disclosure, the following is a detailed description of a debugging method for driving waveform of an electronic paper device provided by embodiments of the present disclosure.

When the step S101 is specifically implemented, since the imaging of the electronic paper device is greatly affected by the ambient temperature, when the electronic paper device is iteratively debugged for multiple times, it is necessary to respectively perform iterative debugging process in the environment of multiple different temperature sections, and output a corresponding target driving waveform at each temperature section. Specifically, the ambient temperature to which the electronic paper device is exposed is first adjusted so that the ambient temperature is at a plurality of different temperature sections. Each temperature section is taken as a target temperature section, and the driving waveform of the electronic paper device at the target temperature section is subjected to a plurality of iterative debugging process. The target temperature section is any one of all the temperature sections. Exemplarily, the temperature section of the environment in which the electronic paper device is imaged is 0-40° C. The temperature section is divided into a plurality of different temperature sections, such as 0° C.-10° C., 10° C.-20° C., 20° C.-30° C., and 30° C.-40° C. The ambient temperature of the electronic paper device is adjusted according to each temperature section in turn, and the driving waveform of the electronic paper device is respectively adjusted at the ambient temperature of each temperature section.

In addition, before performing iterative debugging process, a debugging device is initialized, and a parameter setting interface of the debugging network is displayed on a display interface of the debugging device. A user sets an update coefficient in the debugging network in advance via the parameter setting interface. The update coefficient is a weight factor required for calculating loss when updating the debugging network, and is used for adjusting a parameter updating process of the debugging network. An update factor setting is then performed on the debug network in response to an update factor entered by the user via the parameter setting interface, the update factor.

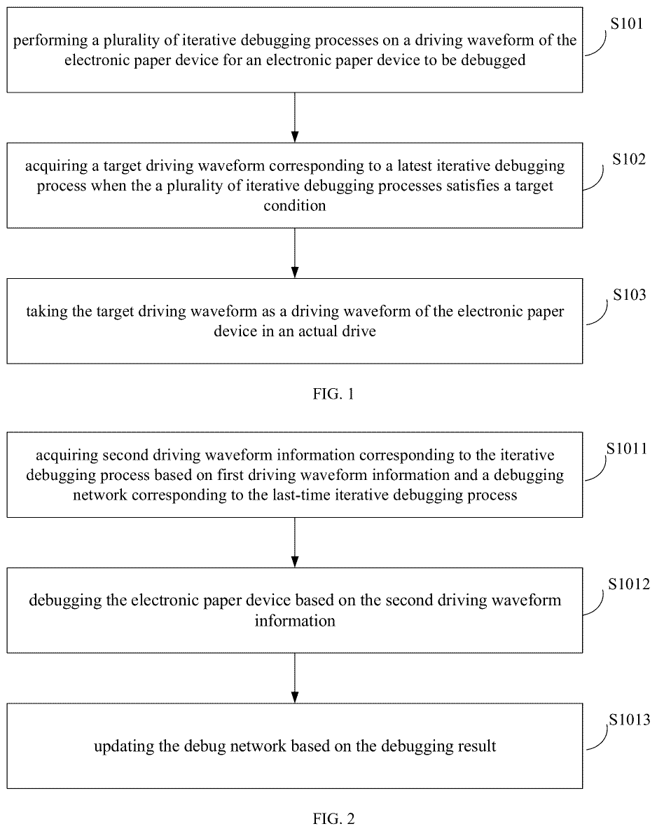

FIG. 2 schematically shows a flowchart for each iteration of a debugging of driving waveform of an electronic paper device for performing the method according to the present disclosure. As shown in FIG. 2, during each iteration of the debugging, the steps of the debugging method of the driving waveform of the electronic paper device are as follows.

S1011, acquiring second driving waveform information corresponding to the iterative debugging process based on first driving waveform information and a debugging network corresponding to the last-time iterative debugging process.

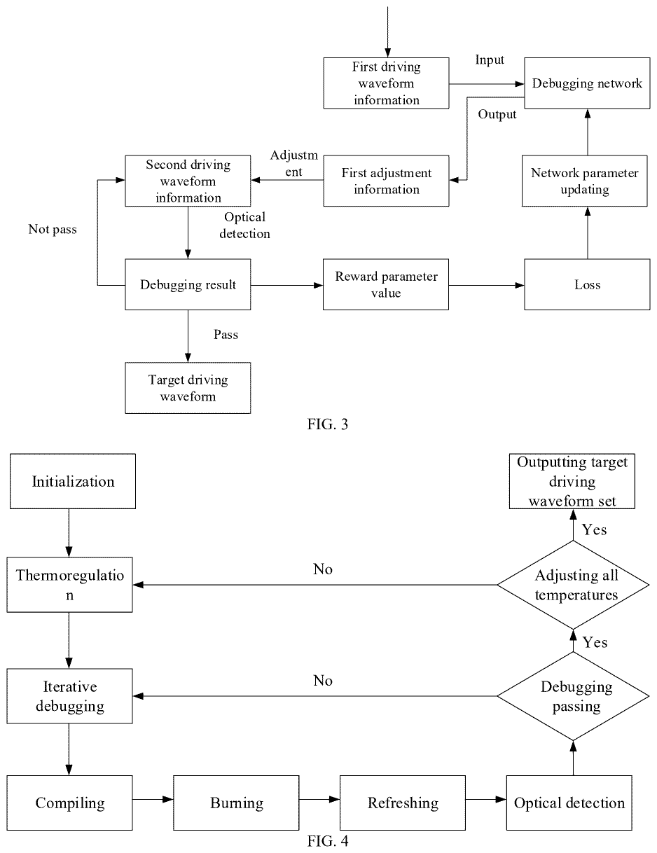

FIG. 3 schematically shows a debugging flow diagram of driving waveform of an electronic paper device for performing the method according to the present disclosure. As shown in FIG. 3, first, the first driving waveform information in a current state is acquired. The first driving waveform information at least includes driving waveform pulse information in the current state, and the first driving waveform information may further include a driving waveform frame in the current state. The first driving waveform information is driving waveform information obtained after the driving waveform information in the previous state is adjusted based on the adjustment information generated by the debugging network. For example, the driving waveform information in the previous state is s₀. The adjustment information regarding the driving waveform information s₀ is a₀. After performing pulse waveform adjustment on the driving waveform information s₀ in the previous state according to the adjustment information a₀, the first driving waveform information S in the current state is obtained. The previous state and the current state may be driving waveform information about the electronic paper device at two consecutive moments, or may be two different driving waveform information about the same electronic paper device to be iteratively debugged.

The first driving waveform information is input to a debug network, which in an embodiment of the present disclosure includes a first sub-network, a second sub-network, a third sub-network, and a fourth sub-network. The first driving waveform information is input into a first sub-network in the debugging network, and the first sub-network selects adjustment information (first adjustment information in FIG. 3) for the first driving waveform information according to the first driving waveform information in the current state. The adjustment information has the same structure as the first driving waveform information, and each value thereof corresponds to an adjustment amplitude and an adjustment direction of a corresponding position in the first driving waveform information.

After obtaining the adjustment information corresponding to the first driving waveform information, the first sub-network adjusts the first driving waveform information according to the adjustment information to obtain the driving waveform information of the next state as the second driving waveform information. Exemplarily, the driving waveform information in the current state is s. The first sub-network generates corresponding adjustment information a for the input driving waveform information s, and obtains the second driving waveform information s′ in the next state after performing pulse waveform adjustment on the driving waveform information S in the current state according to the adjustment information a.

S1012, debugging the electronic paper device based on the second driving waveform information.

After obtaining the second driving waveform information, the second driving waveform information is a new state after adjusting the first driving waveform information in the current state according to the adjustment information generated by the debugging network. The embodiment of the present disclosure updates the debugging network by judging whether the second driving waveform information has a positive influence on the environment, so that the debugging network can strengthen the ability to acquire an optimal driving waveform in the process of iterative debugging process.

FIG. 4 schematically shows a debugging diagram of multiple temperature sections of driving waveform of an electronic paper device for performing the method according to the present disclosure. Firstly, the image refreshing is performed on the electronic paper device based on the second driving waveform information to obtain a first display image. Specifically, the adjusted driving waveform pulse information corresponding thereto is obtained on the basis of the second driving waveform information. When the driving waveform information further includes a driving waveform frame, the adjusted driving waveform frame in the second driving waveform information also needs to be obtained. As shown in FIG. 4, after the second driving waveform information is obtained by iterative debugging process, the driving waveform pulse information, the driving waveform frame and the drive voltage, the reference voltage and the drive frequency of the pre-adjusted colored particles are program compiled to obtain an electronic paper device drive program corresponding to the second driving waveform information. The electronic paper device drive program is burnt into, for example, such as a driving apparatus (such as a driving board) of a debugging device, for executing the electronic paper device drive program to perform image refreshing on the electronic paper device. The colored particles on the electronic paper device generate an electrophoresis phenomenon under the action of a driving waveform corresponding to the second driving waveform information so as to obtain a first display image.

After acquiring the first display image, embodiments of the present disclosure characterize environmental feedback for debugging the electronic paper device based on the second driving waveform information by a first reward parameter value, thereby measuring whether the second driving waveform information is capable of forward debugging the electronic paper device. Specifically, the optical detection is performed on the first display image, and an optical measurement value of the first display image is acquired under a preset color model. The color of the electronic paper device has a reference optical value under the preset color model. The reference optical value may be a range of optical values of the electronic paper device in the preset color model, and thus the reference optical value includes a maximum reference optical value and a minimum reference optical value. If the optical measurement value is less than or equal to the maximum reference optical value and is larger than or equal to the minimum reference optical value, the optical measurement value is within the range of the reference optical value. At this moment, it is considered that debugging the electronic paper device based on the second driving waveform information can correctly display a color. 0 is taken as the first reward parameter value, and the corresponding debugging result thereof characterizes that the debugging process passes. If the optical measurement value is larger than the maximum reference optical value, the optical measurement value is not within the range of the reference optical value. At this moment, it is considered that debugging the electronic paper device based on the second driving waveform information cannot correctly display a color, and the difference value between the optical measurement value and the maximum reference optical value is taken as the first reward parameter value, and the corresponding debugging result thereof represents that the debugging process does not pass. If the optical measurement value is less than the minimum reference optical value, the optical measurement value is not within the range of the reference optical value. At this moment, it is considered that debugging the electronic paper device based on the second driving waveform information cannot correctly display a color. The difference between the optical measurement value and the minimum reference optical value is taken as the first reward parameter value, and the corresponding debugging result thereof characterizes that the debugging process does not pass.

In the case where the debugging result characterizes that the debugging process passes, the second driving waveform information is taken as the target driving waveform output under the current temperature section, and the debugging flow of the current temperature section is ended. In case the debugging result indicates that the debugging process does not pass, the step S1013 is executed to update the debugging network.

In an alternative embodiment, the electronic paper device can be an electronic paper device including a plurality of colors. At this time, the electronic paper device is subjected to image refreshing on the basis of an electronic paper device drive program corresponding to the second driving waveform information, and a plurality of different colored particles on the electronic paper device undergo an electrophoresis phenomenon under the action of a driving waveform corresponding to the second driving waveform information, so as to obtain a second display image including a plurality of different color zones.

After acquiring the second display image, it characterizes environmental feedback for debugging the electronic paper device based on the second driving waveform information by a second reward parameter value, thereby measuring whether the second driving waveform information is capable of forward debugging the electronic paper device. Specifically, the optical detection is performed on each color zone in the second display image respectively, and a corresponding optical measurement value of each color zone is acquired in the second display image under a pre-set color model. Each color zone of the electronic paper device has a different reference optical value under a preset color model. Based on the optical measurement value of the each color zone and the reference optical value of the color zone not given by the electronic paper device, an optical difference value corresponding to each color zone is acquired. The sum of the optical difference values corresponding to all the color zones is taken as a second reward parameter value.

If the second reward parameter value is 0, it is considered that debugging the electronic paper device based on the second driving waveform information can enable each color zone of the electronic paper device to display a color correctly, and then the debugging result corresponding to the second reward parameter value represents that the debugging process passes. If the second reward parameter value is not 0, it is considered that debugging the electronic paper device based on the second driving waveform information cannot enable each color zone of the electronic paper device to correctly display a color, and the debugging result corresponding to the second reward parameter value represents that the debugging process does not pass, with a parameter of a debugging network required to be updated.

Exemplarily, for a three-color electronic paper device of black, white and red, the electronic paper device is subjected to a refreshing process based on an electronic paper device drive program corresponding to the second driving waveform information, and the electronic paper device is refreshed into a second display image containing three color zones of black, white and red. Since the red zone is mainly determined by the value of a and the black zone and the white zone are mainly determined by the value of L, it is only necessary to acquire the optical measurement value a and the optical measurement value L for each color zone. The optical measurement values in the Lab color space of the black zone, the white zone and the red zone are detected, respectively, so as to obtain an optical measurement value L_{b}, a_{b} in the black zone, an optical measurement value L_{w}, a_{w} in the white zone and an optical measurement value Ly, aᵣ in the red zone. The range of the reference optical value L of the black area in the three-color electronic paper device is [L_{b_min}, L_{b_max}], and the range of the reference optical value a is [a_{b_min}, a_{b_max}]; the range of the reference optical value L in the white zone is [L_{w_min}, L_{w_max}], and the range of the reference optical value a is [a_{w_min}, a_{w_max}]; and the reference optical value L in the red zone has a range of Ly min, Ly max, and the reference optical value a has a range [a_{r_min}, a_{r_max}].

The optical difference value is obtained according to the following formula.

$${L}_{b \_ error} = max ( max ( {L}_{b} - {L}_{b \_ max} , {L}_{b \_ min} - {L}_{b} ) , 0 )$$

$${a}_{b \_ error} = max ( max ( {a}_{b} - {a}_{b \_ max} , {a}_{b \_ min} - {a}_{b} ) , 0 )$$

$${L}_{w \_ error} = max ( max ( {L}_{w} - {L}_{w \_ max} , {L}_{w \_ min} - {L}_{w} ) , 0 )$$

$${a}_{w \_ error} = max ( max ( {a}_{w} - {a}_{w \_ max} , {a}_{w \_ min} - {a}_{w} ) , 0 )$$

$${L}_{r \_ error} = max ( max ( {L}_{r} - {L}_{r \_ max} , {L}_{r \_ min} - {L}_{r} ) , 0 )$$

$${a}_{r \_ error} = max ( max ( {a}_{r} - {a}_{r \_ max} , {a}_{r \_ min} - {a}_{r} ) , 0 )$$

Herein, L_{b_error} is an optical difference value L of the black zone, L_{b} is an optical measurement value L of the black zone, L_{b_max} is a maximum reference optical value L of the black zone, and L_{b_min} is a minimum reference optical value L of the black zone. a_{b_error} is an optical difference value a of the black zone, a_{b} is an optical measurement value a of the black zone, a_{b_max} is a maximum reference optical value a of the black zone, and a_{b_min} is a minimum reference optical value a of the black zone. L_{w_error} is the optical difference value L of the white zone, L_{w} is the optical measurement value L of the white zone, L_{w_max} is the maximum reference optical value L of the white zone, and L_{w_min} is the minimum reference optical value L of the white zone. a_{w_error} is the optical difference value a of the white zone, a_{w} is the optical measurement value a of the white zone, a_{w_max} is the maximum reference optical value a of the white zone, a_{w_min} is the minimum reference optical value a of the white zone. L_{r_error} is an optical difference value L in the red zone, Lᵣ is an optical measurement value L in the red zone, L_{r_max} is a maximum reference optical value L in the red zone, and L_{r_min} is a minimum reference optical value L in the red zone. a_{r_error} is the optical difference value a of the red zone, aᵣ is the optical measurement value a of the red zone, a_{r_max} is the maximum reference optical value a of the red zone, and a_{r_min} is the minimum reference optical value a of the red zone.

After obtaining the optical difference value for each color zone, a second reward parameter value is obtained according to the following formula:

$$reward = - ( {L}_{b \_ error} + {a}_{b \_ error} + {L}_{w \_ error} + {a}_{w \_ error} + {L}_{r \_ error} + {a}_{r \_ error} )$$

where reward is a second reward parameter value.

A second reward parameter value is calculated according to the above formula. In the calculation process of each optical difference value, when the optical measurement value is between the maximum reference optical value and the minimum reference optical value, the optical difference value is 0. The optical difference value is larger than 0 when the optical measurement value is not between the maximum reference optical value and the minimum reference optical value. When all the optical difference values are 0, the second reward parameter value is 0, and the debugging result is characterized as passing. When there is at least one optical difference value larger than 0, the second reward parameter value is less than 0, and the debugging result is characterized as not passing.

It should be noted that the above-mentioned example is merely a specific way to provide a person skilled in the art with a better understanding of the solution of the present disclosure, and the way in which the value of the second reward parameter can be obtained can be determined according to actual situations. The present disclosure is not limited herein.

The embodiment of the present disclosure performs optical detection on the generated second driving waveform information during each iteration of debugging, acquires the environmental feedback of the debugging result of the driving waveform of the electronic paper device when the first driving waveform information is adjusted according to the adjustment information as a reward parameter value, measures whether the debugging process passes based on the reward parameter value, and incorporates the environmental feedback of the debugging the electronic paper device into the consideration standard of the debugging result in the form of the reward parameter value, improving the accuracy of the debugging result.

S1013, updating the debugging network based on the debugging result.

In the case where the debugging result characterizes that the debugging process does not pass, after obtaining the first reward parameter value, the first driving waveform information, the second driving waveform information, the adjustment information corresponding to the first driving waveform information and the first reward parameter value are combined into a tetrad corresponding to the current state into an experience pool. The experience pool includes the tetrad corresponding to each state, and the experience pool is used for updating the debugging network.

When the second driving waveform information is input into the second sub-network, the second sub-network acquires a first expected revenue based on the second driving waveform information and the first driving waveform information. The first expected revenue is used for characterizing the revenue of the debugging network for adjusting the first driving waveform information based on the adjustment information. A pre-set number of tetrads are randomly extracted in the experience pool, and a training data set is constructed. Since each tetrad acquires a first expected revenue corresponding to the first driving waveform information in each tetrad when the debugging process does not pass, the training data set likewise corresponds to the same pre-set number of first expected revenues. Based on these first expected revenues corresponding to the training data set, a first loss is acquired; and the parameter of the first sub-network is updated based on the first loss.

In an alternative embodiment, the first loss is obtained as follows.

$${Loss}_{1} = - \frac{1}{m} \sum Q ( s , a )$$

Here, Loss₁ is the first loss; m is a pre-set number of the tetrads; Q(s, a) is the first expected revenue; S is the first driving waveform information; and a is the adjustment information corresponding to the first driving waveform information.

In an alternative embodiment, in the case where the debugging result characterizes that the debugging process does not pass, the second driving waveform information is input into the third sub-network. The third sub-network generates adjustment information corresponding to the second driving waveform information based on the second driving waveform information, and adjusts the second driving waveform information according to the adjustment information. The second driving waveform information and the adjustment information for adjusting the second driving waveform information are input into the fourth sub-network. The fourth sub-network acquires a second expected revenue based on the second driving waveform information and the second driving waveform information and corresponding adjustment information thereof (the second driving waveform information and the corresponding adjustment information thereof can be combined into driving waveform information in a next state). The second expected revenue is used for characterizing the revenue of the debugging network for adjusting the second driving waveform information based on the adjustment information.

After constructing the training data set, since each tetrad acquires a second expected revenue corresponding to the second driving waveform information in each tetrad when the debugging process does not pass, the training data set likewise corresponds to the same preset number of second expected revenues. Based on these second expected revenues corresponding to the training data set and the first reward parameter value, an overall expected revenue is acquired. The overall expected revenue integrates the revenue of the environmental feedback (the first reward parameter value) and the expected revenue of the debugging network itself (the second expected revenue), and the overall expected revenue is acquired according to the following formula:

$$y = r + γ Q ( {s}^{′} , {a}^{′} )$$

where, y is the overall expected revenue; Q(s′, a′) is the second expected revenue; s′ is the second driving waveform information; a′ is the adjustment information corresponding to the second driving waveform information; r is the first reward parameter value; and γ is the discount factor.

Finally, a second loss is obtained based on the overall expected revenue and the first expected revenue, and a parameter of the second sub-network is updated based on the second loss.

In an alternative embodiment, the second loss is obtained according to the following formula:

$${Loss}_{2} = - \frac{1}{m} \sum {( y - Q ( s , a ) )}^{2}$$

where Loss₂ is the second loss; m is a pre-set number of the tetrads; Q(s, a) is the first expected revenue; S is the first driving waveform information; and a is adjustment information corresponding to the first driving waveform information.

In an alternative embodiment, in order to avoid the non-convergence problem caused by the loss of oscillation during the debugging process. After updating the parameter of the first sub-network and the parameter of the second sub-network, updating the debugging network in each iteration of the debugging process is completed. After each preset number of iterative debugging process rounds, the parameter of the third sub-network and the fourth sub-network are updated, so as to effectively reduce the problem of non-convergence caused by loss oscillation. After a preset round of iterative debugging process, a parameter of the third sub-network is updated based on the updated parameter of the first sub-network. The parameter of the fourth sub-network is updated based on the updated parameter of the second sub-network. Herein, the parameter of the third sub-network and the fourth sub-network are updated according to the following formula:

$${w}^{′} ← σ w + ( 1 - σ ) {w}^{′}$$

$${θ}^{′} ← σθ + ( 1 - σ ) {θ}^{′}$$

where w′ is a parameter of the fourth sub-network; w is a parameter of the second sub-network; θ′ is a parameter of a third sub-network; θ is a parameter of a first sub-network; and σ is a soft update coefficient.

When the step S102 is embodied, in the course of each iterative debugging process, a reward parameter value (a first reward parameter value or a second reward parameter value as described above) is acquired based on the first driving waveform information of the current state, and a debugging result is acquired based on the reward parameter value. When the debugging result indicates that the debugging process does not pass, the parameters in the debugging network are updated. The updated debugging network is applied to the driving waveform information in the next state, and the iterative debugging process is repeated until the debugging is stopped when the target condition is met.

Here, the target condition may characterize a debugging process pass for a debugging result, and/or the number of iterative debugging process reaches a pre-set number threshold. When the debugging result obtained based on the reward parameter value in the iterative debugging process characterizes that the debugging process passes, it shows that the driving waveform information obtained in the debugging process can make the color display of the electronic paper device normal, then the iterative debugging process is stopped, and the driving waveform information obtained this time is taken as the target driving waveform under the temperature section. When in the process of iterative debugging process, the debugging result obtained based on the reward parameter value represents that the debugging process does not pass, but the number of times of continuous iterative debugging process reaches a preset number of times threshold value. The target driving waveform corresponding to the latest iterative debugging process is relatively the most accurate driving waveform information to be debugged within the preset number of times, then the process of iterative debugging process is stopped, and the driving waveform information obtained this time is taken as the target driving waveform under the temperature section.

In an alternative embodiment, when a plurality of iterative debugging process is performed under the target temperature section until a target condition is satisfied, a target driving waveform corresponding to the latest iterative debugging process is acquired as the target driving waveform corresponding to the target temperature section. The target driving waveform obtained by the iterative debugging process under the target temperature section is placed into a target driving waveform set.

As shown in FIG. 4, whenever a target driving waveform corresponding to one temperature section is added to a target driving waveform set, it is judged whether the target driving waveform set includes preset target driving waveforms corresponding to all the temperature sections. If the target driving waveform set contains target driving waveforms corresponding to all temperature sections, the target driving waveform set is taken as a driving waveform of the electronic paper device for each temperature section in the actual drive, and the target driving waveform set is stored for actually driving the electronic paper device. If the target driving waveforms corresponding to all the temperature sections are not contained in the target driving waveform set, one temperature section not contained is selected as the target temperature section. The iterative debugging process is performed on the driving waveform corresponding to the target temperature section, and the target driving waveform corresponding to the temperature section is output to the target driving waveform set. The above-mentioned determining process is repeated until the target driving waveform corresponding to all the temperature sections is contained in the target driving waveform set.

In the specific implementation of the step S103, the target driving waveform is taken as the driving waveform of the electronic paper device in actual driving, and the electronic paper device is driven according to the target driving waveform. Specifically, a driving waveform frame and driving waveform pulse information are acquired based on the target driving waveform, wherein the driving waveform frame is used for characterizing a voltage sequence of the target driving waveform, and the driving waveform pulse information is used for characterizing the number of pulses and the number of cycles under the driving waveform frame; the program compilation is performed on the driving waveform frame and the driving waveform pulse information to obtain an electronic paper device drive program; and the electronic paper device drive program is executed to refresh the electronic paper device according to the target driving waveform to form a first target display image.

In an alternative embodiment, after acquiring the target driving waveform set, since the drive of the electronic paper device is greatly influenced by the ambient temperature, it is necessary to firstly acquire the ambient temperature to which the electronic paper device is currently located in the actual drive process. The debugging temperature section is determined based on the ambient temperature. The debugging temperature section is a temperature section to which the ambient temperature belongs. The target driving waveform set for the debugging temperature section is determined based on the debugging temperature section. The electronic paper device is refreshed according to the target driving waveform for the debugging temperature section to form a second target display image.

In an alternative embodiment, the electronic paper device is an electronic paper device of a first model, and after taking the target driving waveform as a driving waveform of the electronic paper device in actual driving, since the target driving waveform can normally display the color contained therein for the first type of the electronic paper device within all preset temperature sections, when the first type of the electronic paper device contains an electronic paper device of a second type of the same color type, it is not necessary to perform iterative debugging process again for the electronic paper device of the second type. The target driving waveform (or set of target driving waveforms) corresponding to the first type of electronic paper device can be directly multiplexed to drive the second type of electronic paper device.

In order that those skilled in the art may more clearly understand the aspects of the present disclosure, a method of debugging driving waveform of an electronic paper device according to the present disclosure will now be described in detail by way of the following examples.

The debugging device for the driving waveform includes a PC, a driving board, an optical measuring instrument and a thermostat. During the iterative debugging process, the electronic paper device is connected to the driving plate via a FPC connecting line, and the driving plate and the optical measuring instrument are connected to the PC via a USB connecting line to constitute the main body of the debugging device. The main body of the debugging device is placed in the thermostat to constitute the debugging device. Herein, an optical measuring instrument is mounted directly above the electronic paper device and is controllable by the PC to be displaced in a given space in order to align the electronic paper device for measuring.

As shown in FIG. 4, after the debugging device is connected, a debugging item of the driving waveform of the electronic paper device is created and initialized on the PC, and a parameter setting interface of the debugging network is displayed on a display interface of the PC. A user sets an update coefficient in the debugging network in advance via the parameter setting interface.

The driving waveform information about the current state in the current temperature section is acquired as first driving waveform information. When the current state is not an initial state, the driving waveform information about the current state is the driving waveform information obtained after the driving waveform information in the previous state being adjusted based on adjustment information generated by a debugging network. When the current state is the initial state, the driving waveform information of the initial state is taken as the first driving waveform information. After obtaining the adjustment information corresponding to the first driving waveform information, the first sub-network adjusts the first driving waveform information according to the adjustment information to obtain the driving waveform information of the next state as the second driving waveform information.

The adjusted driving waveform pulse information corresponding thereto is obtained on the basis of the second driving waveform information. When the driving waveform information further includes a driving waveform frame, the adjusted driving waveform frame in the second driving waveform information also needs to be obtained. The program compilation is performed on the driving waveform pulse information (decimalism), a driving waveform frame and a pre-adjusted drive voltage, a reference voltage and a drive frequency of the colored particles to obtain an electronic paper device driver program (hexadecimal) of a AXF file corresponding to the second driving waveform information. The electronic paper device driver is burnt into, for example, a drive plate, for executing the electronic paper device driver to perform image refreshing on the electronic paper device. The colored particles on the electronic paper device generate an electrophoresis phenomenon under the action of a driving waveform corresponding to the second driving waveform information so as to obtain a first display image.

A specified color zone of the electronic paper device is measured by a PC mobile optical measuring instrument, and a corresponding optical measurement value is displayed and recorded under a Lab color model. A first reward parameter value is calculated based on the optical reference value, and a debugging result is obtained based on the first reward parameter value. If the debugging result indicates that the debugging process passes, the driving waveform information obtained this time is taken as the target driving waveform in the temperature section.

If the debugging result indicates that the debugging process does not pass, after obtaining the first reward parameter value, the first driving waveform information, the second driving waveform information, the adjustment information corresponding to the first driving waveform information and the first reward parameter value are combined into a tetrad corresponding to the current state and placing same into the experience pool. A pre-set number of tetrads are randomly extracted in the experience pool, and a training data set is constructed. Since each tetrad acquires a first expected revenue corresponding to the first driving waveform information in each tetrad when the debugging process does not pass, the training data set likewise corresponds to the same pre-set number of first expected revenues. Based on these first expected revenues corresponding to the training data set, a first loss is acquired; and the parameter of the first sub-network is updated based on the first loss.

The second driving waveform information is input into the third sub-network. The third sub-network generates adjustment information corresponding to the second driving waveform information based on the second driving waveform information, and adjusts the second driving waveform information according to the adjustment information. The second driving waveform information and the adjustment information for adjusting the second driving waveform information are input into the fourth sub-network. An overall expected revenue is obtained based on these second expected revenues corresponding to the training data set and the first reward parameter value to finally obtain a second loss based on the overall expected revenue and the first expected revenue, and update the parameter of the second sub-network based on the second loss.

After a preset round of iterative debugging process, a parameter of the third sub-network is updated based on the updated parameter of the first sub-network. The parameter of the fourth sub-network is updated based on the updated parameter of the second sub-network.

The driving waveform information about a next state is input into an updated debugging network, the above-mentioned iterative debugging process is repeated until the debugging result characterizes that the debugging process passes, and/or the number of times of the iterative debugging process reaches a preset number of times threshold. The target driving waveform corresponding to the latest iterative debugging process is taken as the target driving waveform under the temperature section. The target driving waveform obtained by the iterative debugging process is put at this temperature section (target temperature section) into the target driving waveform set.

It is determined whether the target driving waveform set includes preset target driving waveforms corresponding to all the temperature sections. If the target driving waveform set contains target driving waveforms corresponding to all temperature sections, the target driving waveform set is taken as a driving waveform of the electronic paper device for each temperature section in the actual drive, and the target driving waveform set is stored for actually driving the electronic paper device. If the target driving waveforms corresponding to all the temperature sections are not contained in the target driving waveform set, one temperature section not contained is selected as the target temperature section. The iterative debugging process is performed on the driving waveform corresponding to the target temperature section, and the target driving waveform corresponding to the temperature section is output to the target driving waveform set. The above-mentioned judgement process is repeated until the target driving waveform corresponding to all the temperature sections is contained in the target driving waveform set.et driving waveform corresponding to all the temperature sections is contained in the target driving waveform set.

The present disclosure provides a debugging method and apparatus for a driving waveform of an electronic paper device, the method including: performing a plurality of iterative debugging processes on a driving waveform of the electronic paper device for an electronic paper device to be debugged; acquiring a target driving waveform corresponding to a latest iterative debugging process when the a plurality of iterative debugging processes satisfies a target condition; and taking the target driving waveform as a driving waveform of the electronic paper device in an actual drive; wherein, during each iterative debugging process, acquiring second driving waveform information corresponding to the iterative debugging process based on first driving waveform information and a debugging network corresponding to the last-time iterative debugging process, debugging the electronic paper device based on the second driving waveform information, and updating the debugging network based on a debugging result; wherein the debugging network is at least used for acquiring adjustment information for adjusting the first driving waveform information based on the input first driving waveform information, and the second driving waveform information is obtained based on the adjustment information and the first driving waveform information.

The present disclosure performs automatic adjustment on a driving waveform based on a debug network architecture of reinforcement learning, and at the same time obtains feedback of the adjusted driving waveform to the debugging of driving waveform of the electronic paper device, so as to perform iterative update on the debugging network, avoiding the problem of high trial and error cost caused by debugging in a violent and exhaustive manner, and enabling the debugging of the driving waveform of the electronic paper device to be performed in a flow chart manner.

Based on the same inventive concept, an embodiment of the present disclosure provides a debugging apparatus for the driving waveform of the electronic paper device. FIG. 5 schematically shows a debugging apparatus for driving waveform of an electronic paper device for performing the method according to the present disclosure. As shown in FIG. 5, the apparatus includes:
an iterative debugging process module configured for performing a plurality of iterative debugging processes on a driving waveform of the electronic paper device for an electronic paper device to be debugged;
a determining module configured for acquiring a target driving waveform corresponding to a latest iterative debugging process when the a plurality of iterative debugging processes satisfies a target condition;
a driving waveform acquisition module configured for taking the target driving waveform as a driving waveform of the electronic paper device in an actual drive; and
a single iteration module configured for, during each iterative debugging process, acquiring second driving waveform information corresponding to the iterative debugging process based on first driving waveform information and a debugging network corresponding to the last-time iterative debugging process, debugging the electronic paper device based on the second driving waveform information, and updating the debugging network based on a debugging result; wherein the debugging network is at least used for acquiring adjustment information for adjusting the first driving waveform information based on the input first driving waveform information, and the second driving waveform information is obtained based on the adjustment information and the first driving waveform information.

In an alternative embodiment, the single iteration module includes:
a first display sub-module configured for performing image refreshing on the electronic paper device based on the second driving waveform information to obtain a first display image;
a first detection sub-module configured for performing optical detection on the first display image to acquire an optical measurement value corresponding to the first display image; and
a first result acquisition sub-module configured for acquiring the debugging result based on the optical measurement value and a reference optical value of the electronic paper device.

In an alternative embodiment, the single iteration module includes:
a first reward sub-module configured for acquiring a first reward parameter value based on the optical measurement value and the reference optical value, wherein the first reward parameter value is used for characterizing environmental feedback when the first driving waveform information is adjusted according to the adjustment information; and
a second result acquisition sub-module configured for determining the debugging result based on the first reward parameter value.

In an alternative embodiment, the first reward sub-module includes:
a first reward acquisition unit configured for, if the optical measurement value is less than or equal to the maximum reference optical value and is larger than or equal to the minimum reference optical value, taking 0 as the first reward parameter value;
a second reward acquisition unit configured for, if the optical measurement value is larger than the maximum reference optical value, taking a difference between the optical measurement value and the maximum reference optical value as the first reward parameter value; and
a third reward acquisition unit configured for, if the optical measurement value is less than the minimum reference optical value, taking the difference between the optical measurement value and the minimum reference optical value as the first reward parameter value.

In an alternative embodiment, the single iteration module includes:
a second display sub-module configured for performing image refreshing on the electronic paper device based on the second driving waveform information to obtain a second display image, wherein the second display image includes a plurality of color zones;
a second detection sub-module configured for performing optical detection on each color zone to acquire an optical measurement value corresponding to the each color zone;
a difference acquisition sub-module configured for acquiring an optical difference value corresponding to each color zone based on an optical measurement value corresponding to each color zone and a reference optical value of each color zone; and
a third result acquisition sub-module configured for determining the debugging result based on the corresponding optical difference values for all the color zones.

In an alternative embodiment, the third result acquisition sub-module includes:
a second reward unit configured for taking the sum of the optical difference values corresponding to all the color zones as the second reward parameter value; and
a third result acquisition unit configured for determining the debugging result based on the second reward parameter value.

In an alternative embodiment, the single iteration module includes:
a first revenue sub-module configured for inputting the second driving waveform information into the second sub-network to obtain a first expected revenue when the debugging result indicates that the debugging process does not pass, wherein the first expected revenue is used for indicating the revenue of the debugging network for adjusting the first driving waveform information based on the adjustment information; and
a first updating sub-module configured for updating a parameter of the first sub-network based on the first expected revenue.

In an alternative embodiment, the single iteration module includes:
an adjustment sub-module configured for inputting the second driving waveform information into the third sub-network to acquire adjustment information for adjusting the second driving waveform information in the case where the debugging result indicates that the debugging process does not pass;
a second revenue sub-module configured for inputting the second driving waveform information and the adjustment information for adjusting the second driving waveform information into the fourth sub-network to obtain a second expected revenue, wherein the second expected revenue is used for characterizing the revenue of the debugging network for adjusting the second driving waveform information based on the adjustment information; and
a second update sub-module configured for updating a parameter of the second sub-network based on the second expected revenue and the first reward parameter value.

In an alternative embodiment, the single iteration module includes:
a third updating sub-module configured for updating a parameter of the third sub-network based on the updated parameter of the first sub-network; and
a fourth updating sub-module configured for updating a parameter of the fourth sub-network based on the updated parameter of the second sub-network.

In an alternative embodiment, the single iteration module includes:
an interface display sub-module configured for displaying a parameter setting interface of the debugging network; and
a coefficient setting sub-module configured for performing an update coefficient setting on the debugging network in response to an update coefficient input by a user via the parameter setting interface, wherein the update coefficient is used for adjusting a parameter update process of the debugging network.

In an alternative embodiment, the apparatus further includes:
a parsing module configured for acquiring a driving waveform frame and driving waveform pulse information based on the target driving waveform, wherein the driving waveform frame is used for characterizing a voltage sequence of the target driving waveform, and the driving waveform pulse information is used for characterizing the number of pulses and the number of cycles under the driving waveform frame;
a compilation module configured for performing program compilation on the driving waveform frame and the driving waveform pulse information to obtain an electronic paper device drive program; and
   a second target display module configured for executing the electronic paper device drive program to refresh the electronic paper device according to the target driving waveform to form a first target display image.

In an alternative embodiment, the apparatus further includes:
a drive module configured for driving a second type of an electronic paper device based on the target driving waveform, wherein the second type of the electronic paper device includes the same type of color as the first type of electronic paper device.

The embodiments of the device described above are merely illustrative. The units described as separate components may or may not be physically separated. The components displayed as units may or may not be physical units. That is, they can be located in one place or distributed across multiple network units. Depending on actual needs, some or all of the modules can be selected to achieve the purpose of this embodiment. Ordinary persons in the art can understand and implement it without making any creative labor.

The various embodiments of the components of this disclosure can be implemented in hardware, or as software modules running on one or more processors, or as a combination of both. It should be understood by ordinary persons in the art that microprocessors or digital signal processors (DSPs) can be used in practice to implement some or all of the functions of some or all of the components of the computing processing device according to the embodiments of this disclosure. This disclosure can also be implemented as a device or apparatus program (for example, a computer program and a computer program product) for performing part or all of the methods described here. Such programs for implementing this disclosure can be stored on a computer-readable medium or can have one or more signal forms. Such signals can be downloaded from an Internet website, provided on a carrier signal, or provided in any other form.

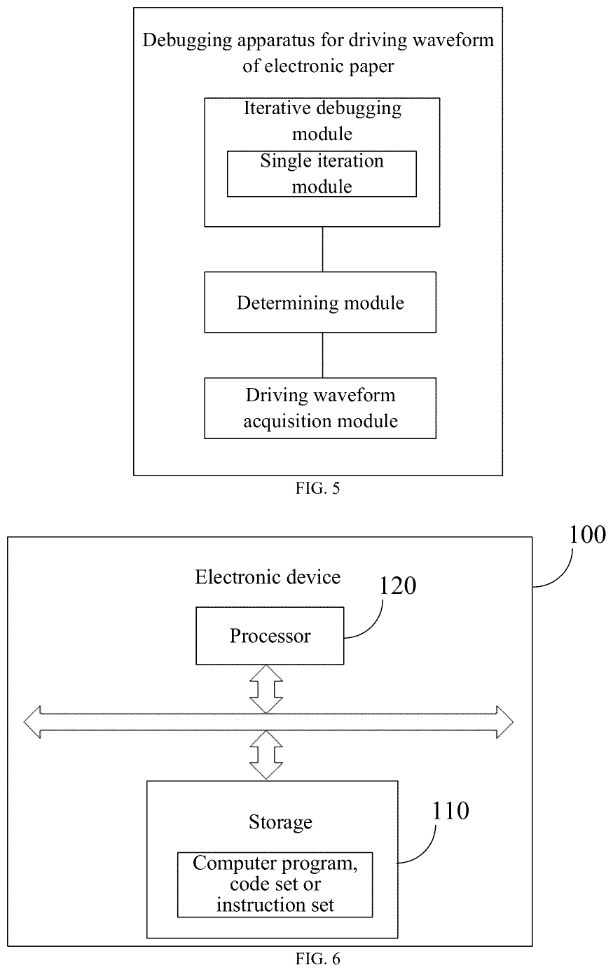

For example, FIG. 6 shows a computing processing device that can implement the method according to this disclosure. The computing processing device 100 traditionally includes a processor 120 and a computer program product or computer-readable medium in the form of a memory 110. The memory 110 can be an electronic memory such as flash memory, EEPROM (electrically erasable programmable read-only memory), EPROM, hard disk, or ROM. The memory 110 has storage space for program code to perform any of the method steps described above. For example, the storage space for program code can include various program codes for implementing the various steps of the above method. These program codes can be read from or written to one or more computer program products. These computer program products include program code carriers such as hard disks, compact discs (CDs), storage cards, or floppy disks. Such computer program products are usually portable or fixed storage units. The storage unit can have storage segments, storage spaces, etc., similar to the memory 110 in the computing processing device shown in FIG. 6. The program code can be, for example, compressed in an appropriate form. Typically, the storage unit includes computer-readable code, that is, code that can be read by a processor such as 120. When run by the computing processing device, this code causes the computing processing device to perform the various steps described above.

The terms “an embodiment,” “embodiment,” or “one or more embodiments” mentioned in this text mean that the specific features, structures, or characteristics described in conjunction with the embodiments are included in at least one embodiment of this disclosure. In addition, please note that the phrase “in one embodiment” does not necessarily refer to the same embodiment.

In the specification provided here, a large number of specific details are described. However, it can be understood that the embodiments of this disclosure can be practiced without these specific details. In some cases, well-known methods, structures, and technologies are not shown in detail to avoid obscuring the understanding of this specification.

In the claims, any reference signs between parentheses should not be construed as a limitation of the claims. The word “comprising” does not exclude the presence of elements or steps not listed in the claims. The word “a” or “an” before an element does not exclude the presence of multiple such elements. This disclosure can be implemented by hardware including several different elements and by a computer appropriately programmed. In the unit claims listing several devices, several of these devices can be embodied by the same hardware item. The use of the words first, second, and third, etc., does not indicate any order. These words can be interpreted as names.

Finally, it should be noted that the above embodiments are only used to illustrate the technical solutions of this disclosure, not to limit it. Although the disclosure has been described in detail with reference to the above embodiments, ordinary person in the field should understand that it can still modify the technical solutions recorded in the above embodiments, or replace some of the technical features with equivalent features. These modifications or replacements do not cause the essential nature of the corresponding technical solutions to deviate from the spirit and scope of the technical solutions of the various embodiments of this disclosure.

1. A debugging method for a driving waveform of an electronic paper device, comprising:
performing a plurality of iterative debugging processes on a driving waveform of the electronic paper device for an electronic paper device to be debugged;
acquiring a target driving waveform corresponding to a latest iterative debugging process when the plurality of iterative debugging processes satisfies a target condition; and
taking the target driving waveform as a driving waveform of the electronic paper device in an actual drive;
wherein, during each iterative debugging process, acquiring second driving waveform information corresponding to the iterative debugging process based on first driving waveform information and a debugging network corresponding to the last-time iterative debugging process, debugging the electronic paper device based on the second driving waveform information, and updating the debugging network based on a debugging result;
wherein the debugging network is at least used for acquiring adjustment information for adjusting the first driving waveform information based on the input first driving waveform information, and the second driving waveform information is obtained based on the adjustment information and the first driving waveform information.

2. The debugging method for the driving waveform of the electronic paper device according to claim 1, wherein the debugging the electronic paper device based on the second driving waveform information comprises:
performing image refreshing on the electronic paper device based on the second driving waveform information to obtain a first display image;
performing optical detection on the first display image to acquire an optical measurement value corresponding to the first display image; and
acquiring the debugging result based on the optical measurement value and a reference optical value of the electronic paper device.

3. The debugging method for the driving waveform of the electronic paper device according to claim 2, wherein the acquiring the debugging result based on the optical measurement value and the reference optical value comprises:
acquiring a first reward parameter value based on the optical measurement value and the reference optical value, wherein the first reward parameter value is used for characterizing environmental feedback when the first driving waveform information is adjusted according to the adjustment information; and
determining the debugging result based on the first reward parameter value.

4. The debugging method for the driving waveform of the electronic paper device according to claim 3, wherein the reference optical value comprises a maximum reference optical value and a minimum reference optical value; and the acquiring a first reward parameter value based on the optical measurement value and the reference optical value comprises:
if the optical measurement value is less than or equal to the maximum reference optical value and is larger than or equal to the minimum reference optical value, taking 0 as the first reward parameter value;
if the optical measurement value is larger than the maximum reference optical value, taking a difference between the optical measurement value and the maximum reference optical value as the first reward parameter value; and
if the optical measurement value is less than the minimum reference optical value, taking the difference between the optical measurement value and the minimum reference optical value as the first reward parameter value.

5. The debugging method for the driving waveform of the electronic paper device according to claim 1, wherein the electronic paper device comprises a plurality of colors, and the debugging the electronic paper device based on the second driving waveform information comprises:
performing image refreshing on the electronic paper device based on the second driving waveform information to obtain a second display image, wherein the second display image comprises a plurality of color zones;
performing optical detection on each color zone to acquire an optical measurement value corresponding to the each color zone;
acquiring an optical difference value corresponding to each color zone based on an optical measurement value corresponding to each color zone and a reference optical value of each color zone; and
determining the debugging result based on the corresponding optical difference values for all the color zones.

6. The debugging method for the driving waveform of the electronic paper device according to claim 5, wherein the determining the debugging result based on the corresponding optical difference values for all the color zones comprises:
taking the sum of the optical difference values corresponding to all the color zones as a second reward parameter value; and
determining the debugging result based on the second reward parameter value.

7. The debugging method for the driving waveform of the electronic paper device according to claim 3, wherein the debugging network comprises a first sub-network and a second sub-network, the first sub-network is configured for outputting adjustment information for adjusting the first driving waveform information, and the updating the debugging network based on the debugging result comprises:
inputting the second driving waveform information into the second sub-network to obtain a first expected revenue when the debugging result indicates that the debugging process does not pass, wherein the first expected revenue is used for indicating the revenue of the debugging network for adjusting the first driving waveform information based on the adjustment information; and
updating a parameter of the first sub-network based on the first expected revenue.

8. The debugging method for the driving waveform of the electronic paper device according to claim 7, wherein the debugging network further comprises a third sub-network and a fourth sub-network, and the updating the debugging network based on the debugging result comprises:
inputting the second driving waveform information into the third sub-network to acquire adjustment information for adjusting the second driving waveform information in the case where the debugging result indicates that the debugging process does not pass;
inputting the second driving waveform information and the adjustment information for adjusting the second driving waveform information into the fourth sub-network to obtain a second expected revenue, wherein the second expected revenue is used for characterizing the revenue of the debugging network for adjusting the second driving waveform information based on the adjustment information; and
updating a parameter of the second sub-network based on the second expected revenue and the first reward parameter value.

9. The debugging method for the driving waveform of the electronic paper device according to claim 8, wherein the updating the debugging network based on the debugging result comprises:
updating a parameter of the third sub-network based on the updated parameter of the first sub-network; and
updating a parameter of the fourth sub-network based on the updated parameter of the second sub-network.

10. The debugging method for the driving waveform of the electronic paper device according to claim 1, wherein before acquiring first driving waveform information, the method further comprises:
displaying a parameter setting interface of the debugging network;
performing an update coefficient setting on the debugging network in response to an update coefficient input by a user via the parameter setting interface, wherein the update coefficient is used for adjusting a parameter update process of the debugging network.

11. The debugging method for the driving waveform of the electronic paper device according to claim 1, wherein, after the taking the target driving waveform as a driving waveform of the electronic paper device in an actual drive, the method further comprises:
acquiring a driving waveform frame and driving waveform pulse information based on the target driving waveform, wherein the driving waveform frame is used for characterizing a voltage sequence of the target driving waveform, and the driving waveform pulse information is used for characterizing the number of pulses and the number of cycles under the driving waveform frame;
performing program compilation on the driving waveform frame and the driving waveform pulse information to obtain an electronic paper device drive program; and
executing the electronic paper device drive program to refresh the electronic paper device according to the target driving waveform to form a first target display image.

12. The debugging method for the driving waveform of the electronic paper device according to claim 1, wherein the electronic paper device is a first type of electronic paper device, and after the taking the target driving waveform as a driving waveform of the electronic paper device in an actual drive, the method further comprises:
driving a second type of an electronic paper device based on the target driving waveform, wherein the second type of the electronic paper device comprises the same type of color as the first type of electronic paper device.

13. (canceled)

14. A computing processing device, comprising:
a memory in which a computer readable code is stored; and
one or more processors, wherein when the computer readable code is executed by the one or more processors, the computing processing device perform operations comprising:
performing a plurality of iterative debugging processes on a driving waveform of the electronic paper device for an electronic paper device to be debugged;
acquiring a target driving waveform corresponding to a latest iterative debugging process when the plurality of iterative debugging processes satisfies a target condition; and
taking the target driving waveform as a driving waveform of the electronic paper device in an actual drive;
wherein, during each iterative debugging process, acquiring second driving waveform information corresponding to the iterative debugging process based on first driving waveform information and a debugging network corresponding to the last-time iterative debugging process, debugging the electronic paper device based on the second driving waveform information, and updating the debugging network based on a debugging result;
wherein the debugging network is at least used for acquiring adjustment information for adjusting the first driving waveform information based on the input first driving waveform information, and the second driving waveform information is obtained based on the adjustment information and the first driving waveform information.

15. A computer-readable medium having stored thereon computer programs/instructions, wherein the computer programs/instructions when executed by a processor implement the debugging method for the driving waveform of the electronic paper device according to claim 1.

16. The computer processing device according to claim 14, wherein the debugging the electronic paper device based on the second driving waveform information comprises:
performing image refreshing on the electronic paper device based on the second driving waveform information to obtain a first display image;
performing optical detection on the first display image to acquire an optical measurement value corresponding to the first display image; and
acquiring the debugging result based on the optical measurement value and a reference optical value of the electronic paper device.

17. The computer processing device according to claim 16, wherein the acquiring the debugging result based on the optical measurement value and the reference optical value comprises:
acquiring a first reward parameter value based on the optical measurement value and the reference optical value, wherein the first reward parameter value is used for characterizing environmental feedback when the first driving waveform information is adjusted according to the adjustment information; and
determining the debugging result based on the first reward parameter value.

18. The computer processing device according to claim 17, wherein the reference optical value comprises a maximum reference optical value and a minimum reference optical value; and the acquiring a first reward parameter value based on the optical measurement value and the reference optical value comprises:
if the optical measurement value is less than or equal to the maximum reference optical value and is larger than or equal to the minimum reference optical value, taking 0 as the first reward parameter value;
if the optical measurement value is larger than the maximum reference optical value, taking a difference between the optical measurement value and the maximum reference optical value as the first reward parameter value; and
if the optical measurement value is less than the minimum reference optical value, taking the difference between the optical measurement value and the minimum reference optical value as the first reward parameter value.

19. The computer processing device according to claim 14, wherein the electronic paper device comprises a plurality of colors, and the debugging the electronic paper device based on the second driving waveform information comprises:
performing image refreshing on the electronic paper device based on the second driving waveform information to obtain a second display image, wherein the second display image comprises a plurality of color zones;
performing optical detection on each color zone to acquire an optical measurement value corresponding to the each color zone;
acquiring an optical difference value corresponding to each color zone based on an optical measurement value corresponding to each color zone and a reference optical value of each color zone; and
determining the debugging result based on the corresponding optical difference values for all the color zones.

20. The computer processing device according to claim 19, wherein the determining the debugging result based on the corresponding optical difference values for all the color zones comprises:
taking the sum of the optical difference values corresponding to all the color zones as a second reward parameter value; and
determining the debugging result based on the second reward parameter value.

21. The computer processing device according to claim 17, wherein the debugging network comprises a first sub-network and a second sub-network, the first sub-network is configured for outputting adjustment information for adjusting the first driving waveform information, and the updating the debugging network based on the debugging result comprises:
inputting the second driving waveform information into the second sub-network to obtain a first expected revenue when the debugging result indicates that the debugging process does not pass, wherein the first expected revenue is used for indicating the revenue of the debugging network for adjusting the first driving waveform information based on the adjustment information; and
updating a parameter of the first sub-network based on the first expected revenue.
